(19) United States
(12) Patent Application Publication
(10) Pub. No.: US 2017/0028925 A1
(43) Pub. Date: Feb. 2, 2017

(54) VEHICLE MIRROR DEVICE

(71) Applicant: KABUSHIKI KAISHA TOKAI-RIKA-DENKI-SEISAKUSHO, Aichi (JP)

(72) Inventors: Kazuyuki YOKOYAMA, Aichi (JP); Masatsugu OHASHI, Aichi (JP); Masahiro ARAI, Aichi (JP)

(21) Appl. No.: 15/302,309

(22) PCT Filed: Jun. 8, 2015
(86) PCT No.: PCT/JP2015/066490

§ 371 Date: Oct. 6, 2016

(30) Foreign Application Priority Data
Jun. 23, 2014 (JP) 2014-128420

(51) Int. Cl. B60R 1/12; B60Q 1/26; F21V 8/00; B60R 1/08

(52) U.S. Cl. CPC B60R 1/1207; B60R 1/082; B60Q 1/2665; G02B 6/0038; G02B 6/0018

(57) ABSTRACT

A door mirror device has a main mirror having a first reflecting surface that enables a periphery of a vehicle to be viewed, and a sub-mirror that is disposed adjacent to the main mirror. The sub-mirror includes a light guide having a light guiding portion into which light from an LED is introduced. A second reflecting surface, that enables a periphery of the vehicle to be viewed, is provided at a surface of the light guide. Further, a light portion, that illuminates, toward an out-of-plane direction of the second reflecting surface, light from the LED that has been introduced into the light guide interior, is provided at the second reflecting surface.

### TECHNICAL FIELD

The present invention relates to a vehicle mirror device.

### BACKGROUND ART

A vehicle mirror device, that makes it possible to view a vehicle obliquely rear side over a wider range by providing a first mirror and a second mirror, is disclosed in U.S. Patent Application Publication No. 2010/0079881.

### SUMMARY OF INVENTION

### Technical Problem

By the way, there are vehicles that are equipped with a blind spot monitor for, while a vehicle is traveling, informing a vehicle occupant that another vehicle exists at an obliquely rear side of that vehicle. Further, for vehicle types at which the buyer can select whether or not to have a blind spot monitor at the time when the buyer purchases the vehicle, there is the need to separately manufacture mirrors that have a light portion of the blind spot monitor and mirrors that do not have a light portion of the blind spot monitor. Namely, it is difficult to devise common usage of parts that structure vehicle mirror devices for these vehicle types.

In view of the above-described circumstances, an object of the present invention is to provide a vehicle mirror device that can devise common usage of structural parts.

### Solution to Problem

A vehicle mirror device of a first aspect of the present invention includes: a first mirror that is provided at a vehicle and that has a first reflecting surface that reflects light; and a second mirror disposed adjacent to the first mirror and structured to include a light guide that has a light guiding portion into whose interior light from a light source is introduced, a second reflecting surface that is provided at a surface of the light guide and that reflects light, and a light portion that is provided at the second reflecting surface and that is lit by the light that has been introduced into the light guide interior.

In accordance with the vehicle mirror device of the first aspect of the present invention, due to a vehicle occupant looking at the first reflecting surface of the first mirror and the second reflecting surface of the second mirror, the vehicle occupant can view the periphery of the vehicle and the like via the first mirror and the second mirror. Further, in the present vehicle mirror device, when light from the light source is introduced through the light guiding portion into the light guide interior, the light portion that is provided at the second reflecting surface of the second mirror is lit.

Here, in the present invention, there is a structure in which the light portion is provided at the second mirror. Therefore, the first mirror of a vehicle mirror device, whose specifications are such that a light portion is provided thereat, and the first mirror of a vehicle mirror device, whose specifications are such that a light portion is not provided thereat, can be used in common.

In a vehicle mirror device of a second aspect of the present invention, in the vehicle mirror device of the first aspect, at a boundary of the first mirror and the second mirror, the first reflecting surface and the second reflecting surface are disposed so as to be offset in a thickness direction of the first mirror.

In accordance with the vehicle mirror device of the second aspect of the present invention, at the boundary portion of the first mirror and the second mirror, due to the positions of the reflecting surfaces of the both being disposed so as to be offset in the thickness direction of the first mirror, offset can be caused between the image that is shown in the first mirror and the image that is shown in the second mirror. Due thereto, misidentification at the time when a vehicle occupant looks at the first mirror and the second mirror can be suppressed.

In a vehicle mirror device of a third aspect of the present invention, in the vehicle mirror device of the first or second aspect, the light guiding portion is disposed so as to face the first mirror in a thickness direction of the first mirror.

In accordance with the vehicle mirror device of the third aspect of the present invention, due to the light guiding portion being disposed at the above-described position with respect to the first mirror, the light source can be disposed so as to face the first mirror. Due thereto, compactness of the dimension, in the thickness direction of the first mirror, of the vehicle mirror device can be devised.

### Advantageous Effects of Invention

The vehicle mirror device relating to the present invention has the excellent effect that common usage of structural parts can be devised.

### BRIEF DESCRIPTION OF DRAWINGS

FIG. 1 is an elevational view showing a vehicle mirror device of a present embodiment.

FIG. 2 is an elevational view that corresponds to FIG. 1 and that shows the vehicle mirror device at a time when a light portion of a blind spot monitor is lit.

FIG. 3 is an enlarged sectional view showing, in an enlarged manner, the cross-section of the vehicle mirror device that is cut along line 3-3 shown in FIG. 1.

### DESCRIPTION OF EMBODIMENTS

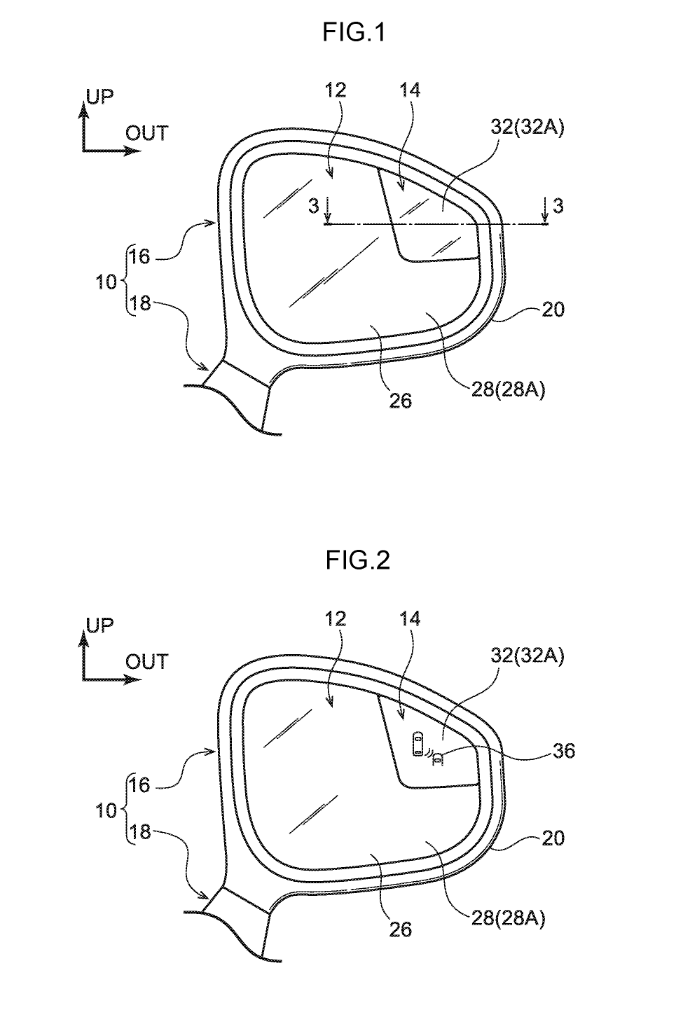

A vehicle mirror device relating to an embodiment of the present invention is described by using FIG. 1 through FIG. 3. Note that the vehicle longitudinal direction frontward side is indicated by arrow FR, the vehicle transverse direction outer side is indicated by arrow OUT, and the vehicle vertical direction upper side is indicated by arrow UP.

As shown in FIG. 1 and FIG. 2, a door mirror device 10 that serves as the vehicle mirror device of the present embodiment is a structure for enabling an occupant of the vehicle to view a vehicle obliquely rear side of the vehicle from the driver's seat due to the door mirror device 10 being mounted to an unillustrated side door. Further, this door mirror device 10 has a light portion 36 of a blind spot monitor that informs the vehicle occupant that another vehicle exists at an obliquely rear side of the own vehicle.

The door mirror device 10 is structured to include a door mirror main body 16 having a main mirror 12 and a sub-mirror 14 for viewing a vehicle obliquely rear side, and a door mirror stay 18 that pivotably supports the door mirror main body 16. Due to an unillustrated actuator, that is provided within the door mirror main body 16, operating, the door mirror main body 16 is pivoted around the door mirror stay 18, and the door mirror main body 16 is pivoted within a range from a stored position to an unfolded position. Note that the door mirror main body 16 that is shown in FIG. 1 and FIG. 2 is positioned at the unfolded position.

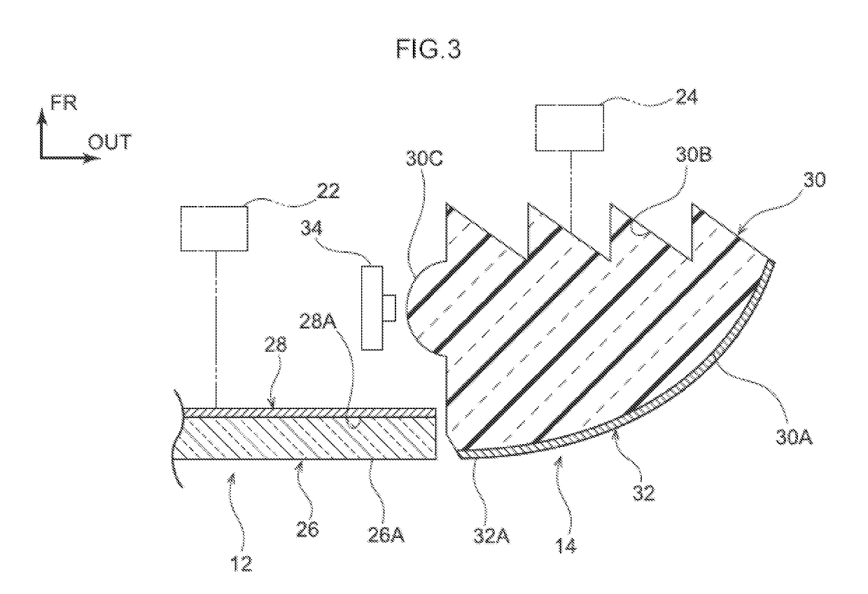

As shown in FIG. 1 and FIG. 3, the door mirror main body 16 is structured to include a cover 20 that forms the contour of the door mirror main body 16, a first mirror adjusting device 22 and a second mirror adjusting device 24 that are disposed at the cover 20 interior, the main mirror 12 that serves as a first mirror and that is supported by the first mirror adjusting device 22, and the sub-mirror 14 that serves as a second mirror and that is supported by the second mirror adjusting device 24.

The main mirror 12 is structured by a metal coating film 28 being deposited on a glass plate 26 that is transparent and that is cut and curved into a predetermined shape. Further, in the present embodiment, the metal coating film 28 is deposited on the surface, that is at the first mirror adjusting device 22 side, of the glass plate 26. Due thereto, a vehicle occupant can view the vehicle rear side by looking at a surface 28A (hereinafter simply called “first reflecting surface 28A”), that is at the glass plate 26 side, of the metal coating film 28. Note that, in the present embodiment, the angle of the main mirror 12 can be adjusted by the first mirror adjusting device 22.

As shown in FIG. 1 and FIG. 2, the sub-mirror 14 is disposed adjacent to the main mirror 12, at a region that is at the vehicle transverse direction outer side of the door mirror main body 16 that is positioned at the unfolded position. As shown in FIG. 3, the sub-mirror 14 is structured by a metal coating film 32 being deposited onto the surface of a light guide 30 that is block-shaped and is formed by using a resin material.

The light guide 30 is formed due to a resin material that is transparent being injected into a mold of a predetermined shape. Further, the surface of the light guide 30, which surface is at the side opposite the second mirror adjusting device 24, is a curved surface 30A whose radius of curvature is smaller than the radius of curvature of the main mirror 12. Further, the metal coating film 32 is deposited along the curved surface 30A. Due thereto, the vehicle occupant can view the vehicle rear side by looking at a surface 32A (hereinafter simply called “second reflecting surface 32A”), which surface is at the side opposite the light guide 30, of the metal coating film 32. Further, in the present embodiment, due to the radius of curvature of the curved surface 30A being set as described above, a vehicle obliquely rear side can be viewed over a wider range. Note that, in the present embodiment, the angle of the sub-mirror 14 can be adjusted by the second mirror adjusting device 24.

Further, at the boundary of the main mirror 12 and the sub-mirror 14, the second reflecting surface 32A and the first reflecting surface 28A are disposed so as to be offset in the thickness direction of the main mirror 12 (the thickness direction of the glass plate 26). In detail, the second reflecting surface 32A is disposed so as to be offset toward the vehicle rear side (the side opposite the light guide 30) with respect to the first reflecting surface 28A. Moreover, at the boundary of the main mirror 12 and the sub-mirror 14, the second reflecting surface 32A and a surface 26A, that is at the side opposite the surface at which the metal coating film 28 is formed, of the glass plate 26 are disposed at the same position in the thickness direction of the main mirror 12 (the thickness direction of the glass plate 26).

The region, that is at the second mirror adjusting device 24 side, of the light guide 30 is a light source reflecting portion 30B that is formed in a saw-blade shape as seen in cross-section. Further, a light guiding portion 30C that projects-out toward the first mirror adjusting device 22 side is provided at the light guide 30 at a region that is further toward the first mirror adjusting device 22 side than the light source reflecting portion 30B. This light guiding portion 30C is disposed so as to face the main mirror 12 in the thickness direction of the main mirror 12 (the thickness direction of the glass plate 26). Further, the light of an LED 34 that serves as a light source is illuminated toward the light guiding portion 30C, and this light is introduced into the light guide 30. Further, that light that has been introduced into the light guide 30 is reflected and diffused toward the curved surface 30A side by the light source reflecting portion 30B.

As shown in FIG. 2, a light portion 36, that illuminates, toward the out-of-plane direction of the metal coating film 32, the light from the LED 34 that was introduced into the light guide 30, is provided at the metal coating film 32. As an example, this light portion 36 is formed by some of the metal coating film 32 being ground, or the like.

### Operation and Effects of the Present Embodiment

Operation and effects of the present embodiment are described next.

As shown in FIG. 1 and FIG. 2, in accordance with the door mirror device 10 of the present embodiment, due to a vehicle occupant looking at the first reflecting surface 28A that structures a portion of the main mirror 12 and the second reflecting surface 32A that structures a portion of the sub-mirror 14, the vehicle occupant can see an obliquely rear side of the vehicle via the main mirror 12 and the sub-mirror 14.

Further, in the present embodiment, when it is detected that another vehicle is approaching an obliquely rear side of the own vehicle, as shown in FIG. 3, the LED 34 lights, and the light from this LED 34 is introduced through the light guiding portion 30C into the light guide 30 interior. Then, the light, that has been introduced into the light guide 30 interior, is reflected and diffused toward the curved surface 30A side by the light source reflecting portion 30B, and the light portion 36 is lit thereby as shown in FIG. 2.

Here, in the present embodiment, the light portion 36 is structured so as to be provided at the sub-mirror 14. Therefore, the main mirror 12 of the door mirror device 10, whose specifications are such that the light portion 36 is to be lit, and the main mirror 12 of a door mirror device, whose specifications are such that a light portion is not to be lit, can be used in common. Namely, in the present embodiment, common usage of the parts that structure the door mirror device 10 can be devised, and accordingly, a decrease in cost of the door mirror device 10 can be devised.

Further, in the present embodiment, at the boundary of the main mirror 12 and the sub-mirror 14, the second reflecting surface 32A and the first reflecting surface 28A are disposed so as to be offset in the thickness direction of the main mirror 12. Due thereto, offset is caused between the image of the periphery of the vehicle that is shown in the main mirror 12 and the image of the periphery of the vehicle that is shown in the sub-mirror 14, and accordingly, misidentification at the time when the vehicle occupant looks at the main mirror 12 and the sub-mirror 14 can be suppressed.

Moreover, in the present embodiment, the light guiding portion 30C of the light guide 30 is disposed so as to face the main mirror 12 in the thickness direction of the main mirror 12. Therefore, the LED 34 can be disposed so as to face the main mirror 12. Due thereto, compactness of the dimension, in the thickness direction of the main mirror 12, of the door mirror main body 16 can be devised.

Note that, in the present embodiment, an example is described in which the light guiding portion 30C of the light guide 30 is disposed so as to face the main mirror 12 in the thickness direction of the main mirror 12, but the present invention is not limited to this. It suffices for the position of the light guiding portion of the light guide 30 to be set appropriately in consideration of the shape and the like of the cover 20.

Further, in the present embodiment, an example is described in which, at the boundary of the main mirror 12 and the sub-mirror 14, the second reflecting surface 32A and the first reflecting surface 28A are disposed so as to be offset in the thickness direction of the main mirror 12. However, the present invention is not limited to this. For example, the second reflecting surface 32A and the first reflecting surface 28A can also be disposed at the same position in the thickness direction of the main mirror 12.

Moreover, in the present embodiment, an example is described in which the light portion 36 of the blind spot monitor is provided at the sub-mirror 14, but the present invention is not limited to this. For example, there also can be a structure in which a light portion, that is for confirming the flashing state of a side turn lamp from the vehicle cabin interior, is provided at the sub-mirror. Further, the present invention can also be applied to another vehicle mirror such as a rearview mirror or the like.

Further, in the present embodiment, an example is described in which a portion of the second reflecting surface 32A of the sub-mirror 14 can be lit, but the present invention is not limited to this. For example, the film thickness of the metal coating film 32 may be made to be thin such that the entire surface of the second reflecting surface 32A can be lit.

Although an embodiment of the present invention has been described above, the present invention is not limited to the above description and can, of course, be implemented by being modified in various ways other than the above within a scope that does not depart from the gist thereof.

The disclosure of Japanese Patent Application No. 2014-128420 that was filed on Jun. 23, 2014 is, in its entirety, incorporated by reference into the present specification.

1. A vehicle mirror device comprising:
a first mirror that is provided at a vehicle and that has a first reflecting surface that reflects light; and
a second mirror disposed adjacent to the first mirror and structured to include a light guide that has a light guiding portion into whose interior light from a light source is introduced, a second reflecting surface that is provided at a surface of the light guide and that reflects light, and a light portion that is provided at the second reflecting surface and that is lit by the light that is introduced into the light guide interior.

2. The vehicle mirror device of claim 1, wherein, at a boundary of the first mirror and the second mirror, the first reflecting surface and the second reflecting surface are disposed so as to be offset in a thickness direction of the first mirror.

3. The vehicle mirror device of claim 1, wherein the light guiding portion is disposed so as to face the first mirror in a thickness direction of the first mirror.

4. The vehicle mirror device of claim 2, wherein the light guiding portion is disposed so as to face the first mirror in a thickness direction of the first mirror.
